(19) United States
(12) Patent Application Publication
(10) Pub. No.: US 2007/0067547 A1
(43) Pub. Date: Mar. 22, 2007

(54) USB device

(75) Inventor: In-Chol Jang, Hwaseong-si (KR)

Correspondence Address: F. CHAU & ASSOCIATES, LLC, 130 WOODBURY ROAD, WOODBURY, NY, 11797, US

(73) Assignee: Samsung Electronics Co., Ltd, Suwon-si (KR)

(21) Appl. No.: 11/508,519

(22) Filed: Aug. 23, 2006

(30) Foreign Application Priority Data
Aug. 25, 2005 (KR) 10-2005-0078422

(51) Int. Cl. G06F 13/20

(52) U.S. Cl. 710/313

(57) ABSTRACT

A universal serial bus (USB) device which can receive power from a USB host or can supply power to a USB device adapter includes a power supply, an internal circuit communicating data with a USB host via a USB device adapter and a USB cable, a first switch which is connected between a terminal of the USB cable and the power supply, the first switch switching between the terminal of the USB cable and the power supply in response to a first control signal, and a second switch which is connected between the terminal of the USB cable and the internal circuit, the second switch switching between the terminal of the USB cable and the internal circuit in response to a second control signal.

### CROSS-REFERENCE TO RELATED PATENT APPLICATION

This application claims the benefit of Korean Patent Application No. 10-2005-0078422, filed on Aug. 25, 2005, in the Korean Intellectual Property Office, the disclosure of which is incorporated herein by reference in its entirety.

### BACKGROUND OF THE INVENTION

1. Field of the Invention

The present invention relates to data communication, and more particularly, to a universal serial bus (USB) device that communicates with a USB host and includes a controllable power supply.

2. Description of Related Art

In order that a USB device can communicate with a USB host in a wired manner, the USB device needs to be connected to the USB host by a USB cable. In order that a USB device can wirelessly communicate with a USB host, a USB host adapter and a USB device adapter are needed. The USB host adapter and the USB device adapter can wirelessly handle data transmitted between the USB host and the USB device.

FIG. 1 is a schematic diagram of a wireless communication path between a USB host 110 and a USB device 140. Referring to FIG. 1, the USB host 110 transmits/receives data using a USB host adapter 120 and a wired USB cable, and the USB device 140 transmits/receives data using a USB device adapter 150 and a wired USB cable. The USB host adapter 120 and the USB device adapter 150 wirelessly transmit/receive data. For this, power is supplied from external power supplies 130 and 160 to the USB host adapter 120 and the USB device adapter 150, respectively. The USB device 140 may be a device, such as a camcorder, which attempts to store data in the USB host 110 (e.g., a computer).

The USB host adapter 120 and the USB device adapter 150 can wirelessly transmit/receive data only when supplied with power. Adapters may be designed to be equipped with embedded power supplies. In this case, however, the size and manufacturing cost of adapters may increase.

Therefore, a need exists for a USB device having a controllable power supply.

### SUMMARY OF THE INVENTION

According to an embodiment of the present invention, a USB device includes a power supply, an internal circuit for communicating data with a USB host via a USB device adapter and a USB cable, a first switch which is connected between a terminal of the USB cable and the power supply, the first switch switching between the terminal of the USB cable and the power supply in response to a first control signal, and a second switch which is connected between the terminal of the USB cable and the internal circuit, the second switch switching between the terminal of the USB cable and the internal circuit in response to a second control signal.

According to another embodiment of the present invention, a USB device includes a power supply, an internal circuit for communicating data with a USB host via a USB device adapter and a USB cable, a first switch which is connected between a terminal of the USB cable and the internal circuit, the first switch switching between the terminal of the USB cable and the internal circuit in response to a first control signal, and a second switch which is connected between the first switch and the power supply, the second switch switching between the first switch and the power supply in response to a second control signal.

According to another embodiment of the present invention, a USB device includes a power supply, an internal circuit for communicating data with a USB host via a USB device adapter and a USB cable, and a switch which is connected between a terminal of the USB cable and the internal circuit, the switch switching between the terminal of the USB cable and the internal circuit in response to a control signal.

### BRIEF DESCRIPTION OF THE DRAWINGS

The present invention will become more apparent by describing in detail exemplary embodiments thereof with reference to the attached drawings in which:

FIG. 1 is a schematic diagram of a wireless communication path between a USB host and a conventional USB device;

FIG. 2 is a schematic diagram of a wireless communication path between a USB host and a USB device according to an exemplary embodiment of the present invention;

FIG. 3 is a block diagram of a USB device according to an exemplary embodiment of the present invention;

FIG. 4 is a block diagram of a USB device according to an exemplary embodiment of the present invention;

FIG. 5 is a block diagram of a USB device according to an exemplary embodiment of the present invention;

FIG. 6 is a block diagram of the USB device of FIG. 3 and a USB host, which are connected to each other by a USB cable; and

FIG. 7 is a block diagram of the USB device of FIG. 3 and a USB device adapter, which are connected to each other by a USB cable.

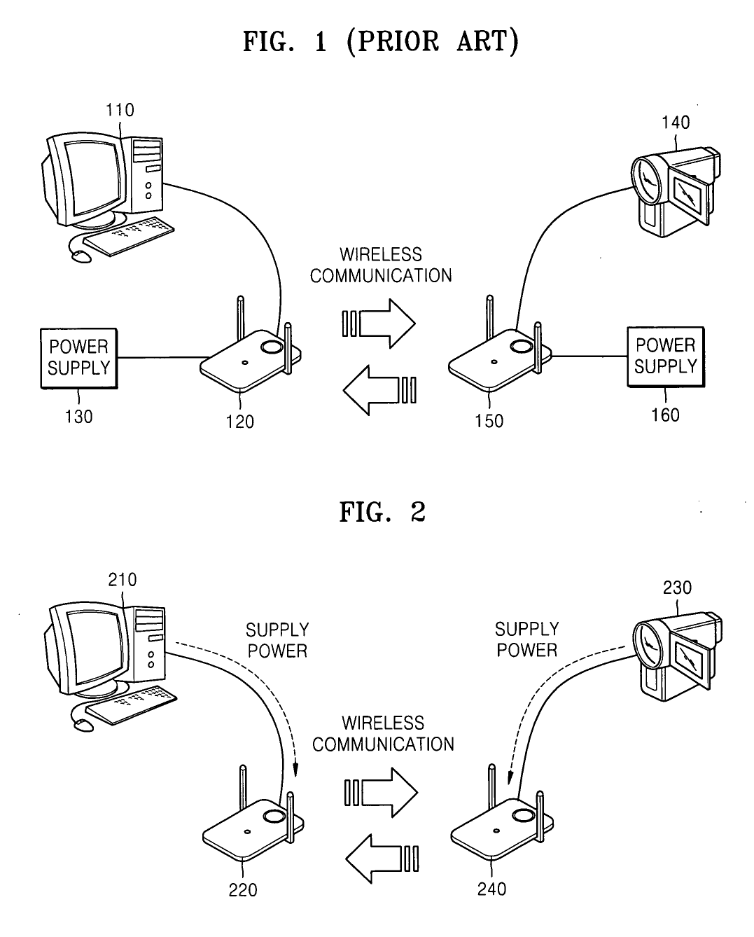

### DETAILED DESCRIPTION OF PREFERRED EMBODIMENTS

The present invention will now be described more fully with reference to the accompanying drawings in which exemplary embodiments of the invention are shown. In the drawings, like reference numerals represent like elements.

FIG. 2 is a schematic diagram of a wireless communication path between a USB host 210 and a USB device 230 according to an exemplary embodiment of the present invention. Referring to FIG. 2, the USB device 230 transmits data to and/or receives data from a USB device adapter 240 via a USB cable and supplies power to the USB device adapter 240 via the USB cable. The USB host 210 transmits data to and/or receives data from a USB host adapter 220 via a USB cable and supplies power to the USB host adapter 220 via the USB cable. The USB host 210 and the USB device 230 supply power to the USB host adapter 220 and the USB device adapter 240, respectively.

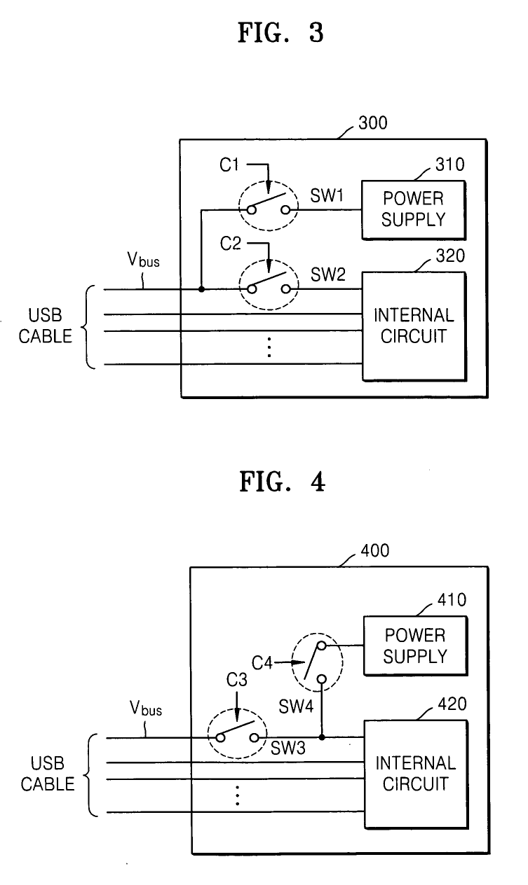

FIG. 3 is a block diagram of a USB device 300 according to an exemplary embodiment of the present invention. Referring to FIG. 3, the USB device 300 includes a power supply 310, an internal circuit 320, and first and second switches SW1 and SW2.

The power supply 310 supplies a predetermined power. The internal circuit 320 performs predetermined functions and transmits/receives data via a USB cable. The first switch SW1 is connected between a terminal of the USB cable and the power supply 310 and switches between the terminal of the USB cable and the power supply 310 in response to a first control signal C1. The second switch SW2 is connected between the terminal of the USB cable and the internal circuit 320 and switches between the terminal of the USB cable and the internal circuit 320 in response to a second control signal C2.

The USB device 300 may also include a control unit (not shown) generating the first and second control signals C1 and C2. The first terminal of the USB cable may be a terminal Vbus for supplying power, e.g., a bus voltage.

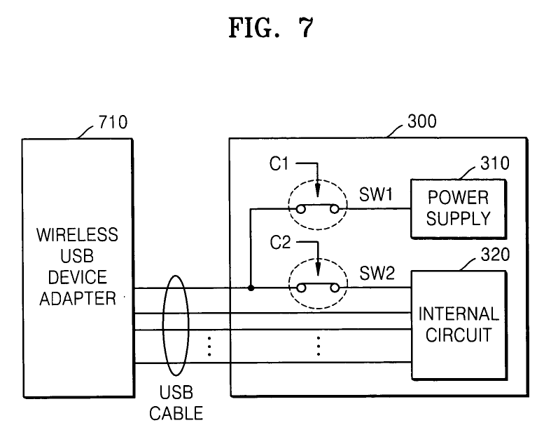

The operation of the USB device 300 when the USB device 300 is connected to a USB host or a USB device adapter will be described in detail with reference to FIGS. 6 and 7.

FIG. 6 is a block diagram of the USB device 300 of FIG. 3 and a USB host 610 which are connected to each other by a USB cable. Referring to FIG. 6, the first switch SW1 is open, and the second switch SW2 is closed when the USB device 300 receives power from the USB host 610 via the USB cable. When the USB device 300 receives power from the power supply 310 without the aid of the USB cable, the first and second switches SW1 and SW2 are both closed.

For the USB device 300 to receive power from the power supply 310, the first and second switches SW1 and SW2 need to be closed. In this case, the USB host 610 is controlled not to supply power to the USB device 300, and a power line may be additionally installed inside the USB device 300 so that power can be directly supplied from the power supply 310 to the internal circuit 320 via the power line.

FIG. 7 is a block diagram of the USB device 300 of FIG. 3 and a USB device adapter 710, which are connected to each other by a USB cable. Referring to FIG. 7, when the USB device 300 is connected to the USB device adapter 710 by a USB cable, the first and second switches SW1 and SW2 are both closed. Accordingly, the power supply 310 supplies power to the internal circuit 320 through the first and second switches SW1 and SW2 and supplies power to the USB device adapter 710 through the first switch SW1.

FIG. 4 is a block diagram of a USB device 400 according to an exemplary embodiment of the present invention. Referring to FIG. 4, the USB device 400 includes a power supply 410, an internal circuit 420, and third and fourth switches SW3 and SW4.

The power supply 410 supplies a predetermined power. The internal circuit 420 performs predetermined functions and transmits data to and/or receives data from a USB host (not shown) or a USB device adapter (not shown) via a USB cable. The third switch SW3 is connected between a terminal Vbus of the USB cable and the internal circuit 420 and switches between the terminal Vbus and the internal circuit 420 in response to a third control signal C3. The fourth switch SW4 is connected between the third switch SW3 and the power supply 410 and switches between the third switch SW3 and the power supply 410 in response to a fourth control signal C4.

The USB device 400 may also include a control unit generating the third and fourth control signals C3 and C4. The terminal Vbus is used for supplying power.

When the USB device 400 receives power from the USB host via the USB cable, the third switch SW3 is closed, and the fourth switch SW4 is open. When the USB device 400 receives power from the power supply 410, the third switch SW3 is open, and the fourth switch SW4 is closed.

When the USB device 400 is connected to a USB device adapter (not shown) by the USB cable, the third and fourth switches SW3 and SW4 are both closed.

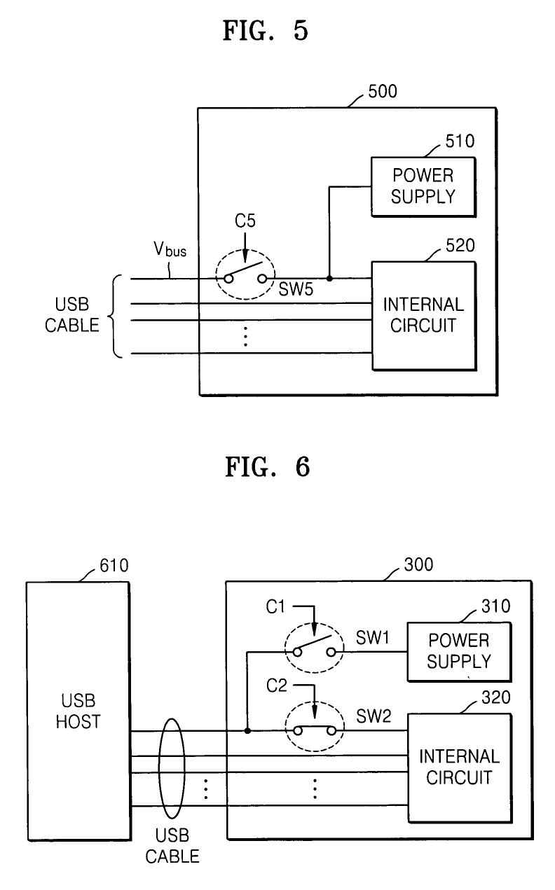

FIG. 5 is a block diagram of a USB device 500 according to an exemplary embodiment of the present invention. Referring to FIG. 5, the USB device 500 includes a power supply 510, an internal circuit 520, and a fifth switch SW5.

The power supply 510 supplies a predetermined power. The internal circuit 520 receives power from the power supply 510 and performs predetermined functions. The internal circuit 520 transmits data to and/or receives data from a USB host or a USB device adapter (not shown) via a USB cable. The fifth switch SW5 is connected between a terminal Vbus of the USB cable and the internal circuit 520 and switches between the terminal Vbus and the internal circuit 520 in response to a fifth control signal C5.

The power supply 510 may also include a control unit (not shown) generating the fifth control circuit C5. The terminal Vbus may be used for supplying power.

When the USB device 500 receives power from the USB host via the USB cable, the fifth switch SW5 is closed, and the power supply 510 stops operating. When the USB device 500 receives power from the power supply 510, the fifth switch SW5 is open.

When the USB device 500 is connected to the USB device adapter by the USB cable and there is a need to supply power from the power supply 510 to the USB device adapter, the switch SW5 is closed.

As described above, a USB device according to the present invention can receive power from a USB host and can supply power to a USB device adapter connected thereto via a USB cable. While the present invention has been particularly shown and described with reference to exemplary embodiments thereof, it will be understood by those of ordinary skill in the art that various changes in form and details may be made therein without departing from the spirit and scope of the present invention.

What is claimed is:

1. A universal serial bus (USB) device comprising:
a power supply;
an internal circuit for communicating data with a USB host via a USB device adapter and a USB cable;
a first switch which is connected between a terminal of the USB cable and the power supply, the first switch switching between the terminal of the USB cable and the power supply in response to a first control signal; and
a second switch which is connected between the terminal of the USB cable and the internal circuit, the second switch switching between the terminal of the USB cable and the internal circuit in response to a second control signal.

2. The USB device of claim 1 further comprising a control unit which generates the first and second control signals.

3. The USB device of claim 1, wherein the terminal of the USB cable is a terminal Vbus for supplying power.

4. The USB device of claim 1, wherein the USB device is connected to the USB host by the USB cable, wherein the first switch is open and the second switch is closed when the USB device receives power from the USB host via the USB cable, and the first and second switches are both closed when the USB device receives power from the power supply.

5. The USB device of claim 1, wherein, when the USB device is connected to the USB device adapter by the USB cable, the first and second switches are both closed.

6. A universal serial bus (USB) device comprising:
a power supply r;
an internal circuit for communicating data with a USB host via a USB device adapter and a USB cable;
a first switch which is connected between a terminal of the USB cable and the internal circuit, the first switch switching between the terminal of the USB cable and the internal circuit in response to a first control signal; and
a second switch which is connected between the first switch and the power supply, the second switch switching between the first switch and the power supply in response to a second control signal.

7. The USB device of claim 6 further comprising a control unit which generates the first and second control signals.

8. The USB device of claim 6, wherein the terminal of the USB cable is a terminal Vbus for supplying power.

9. The USB device of claim 6, wherein the USB device is connected to the USB host by the USB cable, wherein the first switch is closed and the second switch is open when the USB device receives power from the USB host via the USB cable, and the first switch is open and the second switch is closed when the USB device receives power from the power supply.

10. The USB device of claim 6, wherein, when the USB device is connected to the USB device adapter by the USB cable, the first and second switches are all closed.

11. A universal serial bus (USB) device comprising:
a power-supply;
an internal circuit communicating data with a USB host via a USB device adapter and a USB cable; and
a switch which is connected between a terminal of the USB cable and the internal circuit, the switch switching between the terminal of the USB cable and the internal circuit in response to a control signal.

12. The USB device of claim 11 further comprising a control unit which generates the control signal.

13. The USB device of claim 11, wherein the terminal of the USB cable is a terminal Vbus for supplying power.

14. The USB device of claim 11, wherein the USB device is connected to the USB host by the USB cable, wherein the switch is closed when the USB device receives power from the USB host via the USB cable, and the switch is open when the USB device receives power from the power supply.

15. The USB device of claim 14, wherein, when the USB device receives power from the USB host via the USB cable, the power supply is controlled not to operate.

16. The USB device of claim 11, wherein, when the USB device is connected to the USB device adapter by the USB cable, the switch is closed.
